(19) United States
(12) Patent Application Publication
(10) Pub. No.: US 2006/0283858 A1
(43) Pub. Date: Dec. 21, 2006

(54) Wall plate masking device and method

(75) Inventors: Robert Kent Tucker, Temecula, CA (US); Francesco Dorigo, Carlsbad, CA (US); Andrew E. Cover, Fallbrook, CA (US)

Correspondence Address: GORDON & REES LLP, 101 WEST BROADWAY, SUITE 1600, SAN DIEGO, CA, 92101, US

(73) Assignee: Meritage Design, Inc. a California Corporation

(21) Appl. No.: 11/154,790

(22) Filed: Jun. 15, 2005

(51) Int. Cl. H02G 3/14

(52) U.S. Cl. 220/241

(57) ABSTRACT

A masking device designed to cover a wall plate during treatment of a surrounding wall surface has an open face, an outer wall spaced from the open face, and peripheral side walls extending from the periphery of the outer wall to the open face. The side walls form a peripheral rim around the open face which is of predetermined shape and dimensions for closely fitting over the peripheral rim of a selected wall plate. A layer of re-positionable adhesive is applied over the inner face of the peripheral rim for temporarily adhering the rim to the peripheral rim of the wall plate.

### BACKGROUND OF THE INVENTION

The present invention relates generally to protection of fixtures on a surface while the surface is treated by painting, plastering, or the like, and is particularly concerned with a masking or cover device and method used for this purpose.

Interior walls of buildings typically have electrical fixtures such as switches, outlets or sockets, phone jacks, and the like which are covered with relatively flat wall plates which cover the wall opening in which the fixture is mounted and which are secured to lie flat against the wall. When the wall is to be painted, plastered, or treated in some other way, such items must be covered to protect them from paint or other material. Tape such as masking tape is often used for this purpose. Wall plates are often removed prior to wall treatment, and the resultant opening covered with tape. This is both time consuming and inconvenient.

Protective devices have been proposed in the past for use in covering electrical outlets or switch assemblies. U.S. Pat. No. 6,103,974 of Erdfarb describes a cover with one or more arms which frictionally engage the inside of an outlet assembly so as to secure the cover in place. The arms frictionally engage inside the side wall of an outlet box. A tab or aperture must be provided in the cover to allow positioning and subsequent removal of the cover. Since the cover is only attached at one point, it may be loose around the remainder of its periphery to allow paint or other decorative material to enter. Other protective devices require the cover plate to be removed prior to application and require screw fasteners or the like for securing the protective device in position.

### SUMMARY OF THE INVENTION

It is an object of the present invention to provide a new and improved masking or cover device and method for covering electrical fixtures and the like during treatment of surrounding wall surfaces.

According to one aspect of the present invention, a cover or masking device for covering a wall plate during treatment of a surrounding wall surface is provided, which comprises a housing having an open face, an outer wall spaced from the open face, and peripheral side walls extending from the periphery of the outer wall to the open face. The side walls have a peripheral rim extending around the open face which is of predetermined shape and dimensions for closely fitting over the peripheral rim of a selected wall plate. A layer of re-positionable adhesive is applied over the inner face of the peripheral rim for temporarily adhering the rim to the peripheral rim of a wall plate.

The adhesive layer, which may be covered by a peel-off cover strip prior to use of the cover device, temporarily secures the device to the rim of the wall plate after application of the cover device over the wall plate. This ensures that the wall plate is completely shielded from paint or other decorative material during the wall treatment, down to the junction between the wall plate and the wall.

The adhesive is of the type known in the adhesive field as a re-positionable adhesive, which is identical or similar to the adhesive used on Post-It® notes. Such adhesives are pressure sensitive, liquid glues which form a temporary bond to a surface and which can be easily pulled off without leaving any residue on the surface when no longer required.

The cover device may be of thermo-formed plastic material such as PVC which is thin enough to have some resilience. The dimensions of the peripheral rim may be slightly less than those of the rim of the wall plate it is designed to cover, so that the cover device must be forced over the wall plate and the rim will spread slightly over the rim of the wall plate, ensuring good adherence between the rim of the cover device and the rim of the wall plate. The device is very quick and easy to apply, and can be simply pushed or pressed onto the wall plate until the lower edge of the rim contacts the wall at the junction between the wall and rim of the wall plate. This will reduce the chance of any paint flowing under the edge of the cover device and onto any part of the wall plate.

In an exemplary embodiment of the invention, the cover device is of generally rectangular shape with a flat outer wall and outwardly tapered side walls extending from the outer wall to the peripheral rim, and the peripheral rim comprises a downturned edge which substantially matches the shape of the peripheral rim of the wall plate. The device is made in various different sizes corresponding to the sizes of conventional wall plates for covering electrical fixtures such as outlet sockets and switches. The flat outer wall and side walls together define an inner chamber with sufficient clearance to accommodate raised members on a wall plate, such as outwardly projecting switch members and the like.

According to another aspect of the present invention, a method of covering a wall plate during treatment of a surrounding wall surface is provided, which comprises the steps of:

providing a protective cover device for fitting closely over the wall plate, the cover device having a peripheral rim for fitting closely over the peripheral rim of the wall plate, the peripheral rim having an inner face covered by a layer of re-positionable adhesive;

placing the protective cover device over the wall plate such that the peripheral rim of the device engages over the peripheral rim of the wall plate up to the junction between the wall plate and surrounding wall surface;

temporarily adhering the peripheral rim of the cover device to the peripheral rim of the wall plate with the layer of re-positionable adhesive;

treating the wall surface surrounding the wall plate; and

on completion of the wall treatment, removing the protective cover from the wall plate and discarding it.

The wall plate cover device and method of this invention will significantly reduce the time required to prepare the walls of a room for decorating. Rather than having to remove each wall plate and then cover the resultant exposed electrical fixture with masking tape or the like, the decorator simply presses a suitable cover device over every wall plate. Once decorating is complete, the cover devices are simply pulled off and discarded. This also will take much less time than removing masking tape and re-attaching the cover plates. Masking tape also has the disadvantage that it may mar the adjacent painted surface when it is pulled up. The device of this invention is not adhered to the surface, but only to the rim of the wall plate, and there will be no tendency to pull up any paint when it is pulled off.

### BRIEF DESCRIPTION OF THE DRAWINGS

The present invention will be better understood from the following detailed description of some exemplary embodiments of the invention, taken in conjunction with the accompanying drawings in which like reference numerals refer to like parts and in which:

FIG. 1 is a perspective view of a masking device according to a first embodiment of the invention in alignment with a wall plate to be covered, prior to engagement of the masking device over the wall plate;

FIG. 2 is a perspective view similar to FIG. 1 illustrating a masking device according to a second embodiment of the invention for covering a larger size wall plate;

FIG. 3 is a perspective view of the interior of the masking device of FIG. 1, taken from beneath the masking device;

FIG. 4 is a similar perspective view to FIG. 3, illustrating the interior of the masking device of FIG. 2; and

FIG. 5 is a cross sectional view illustrating a masking device engaged over and temporarily attached to a wall plate.

### DETAILED DESCRIPTION OF THE INVENTION

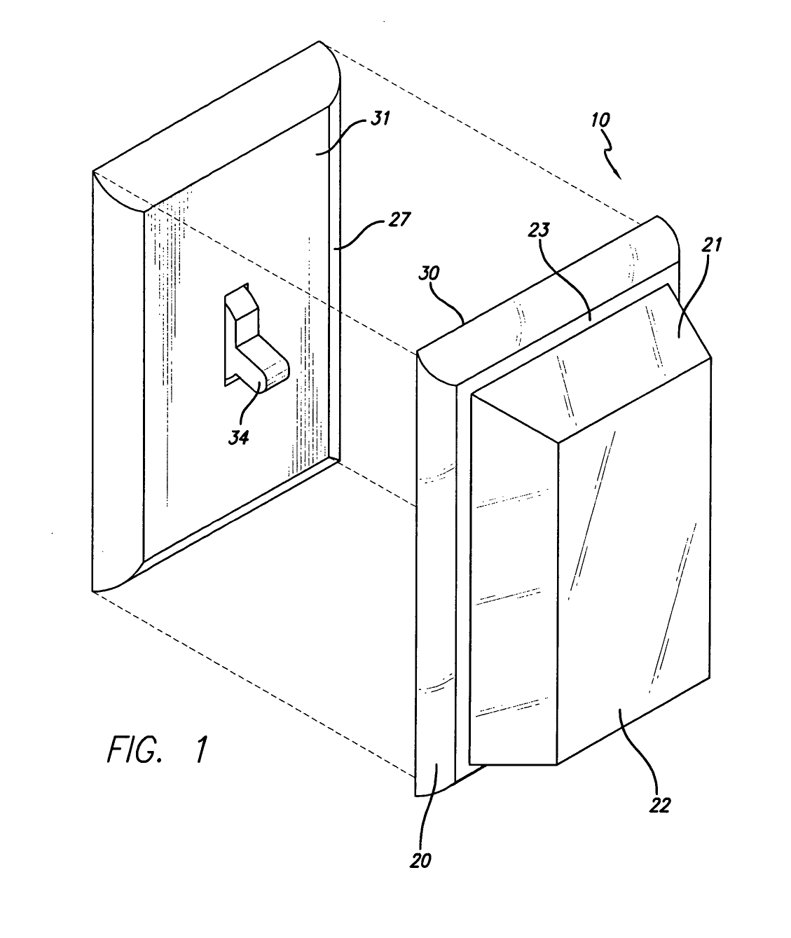

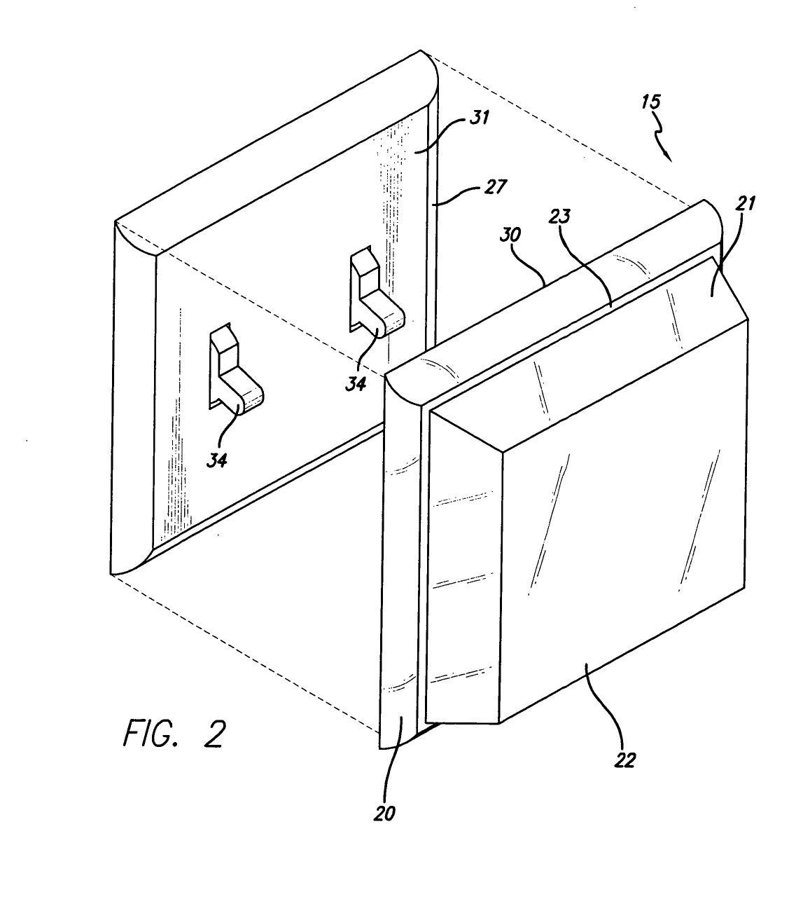

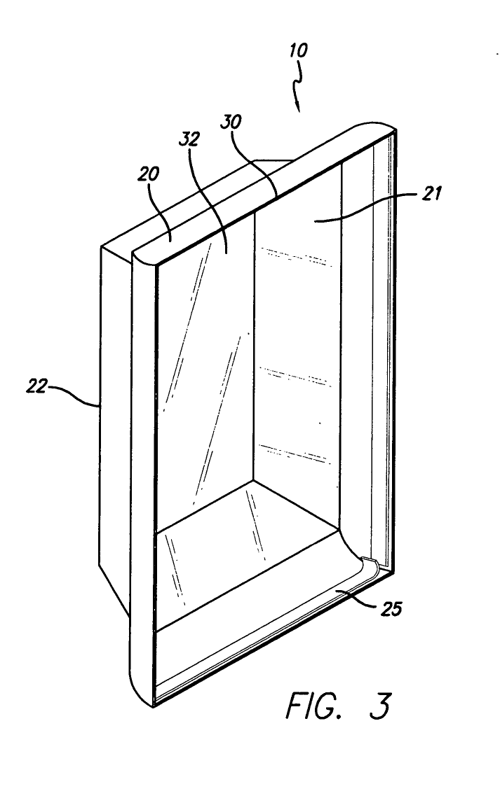

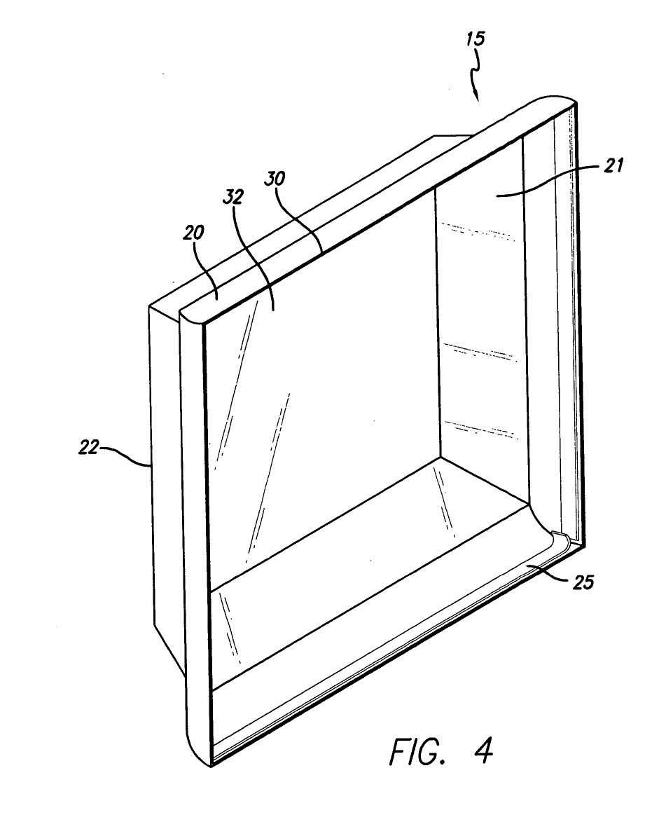

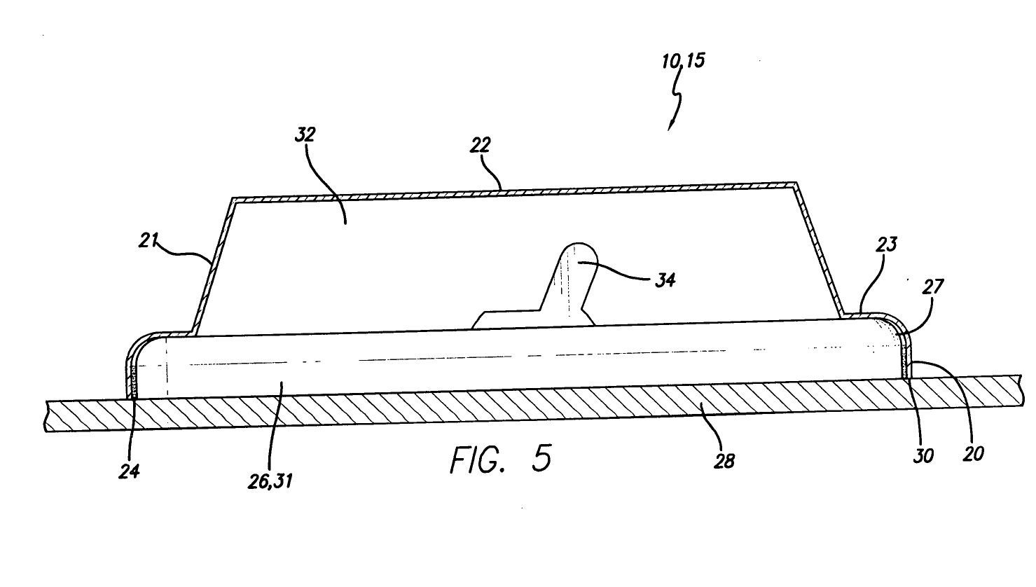

FIGS. 1 and 3 illustrate a wall plate masking or cover device 10 according to a first embodiment of the invention, while FIGS. 2 and 4 illustrate a cover device 15 of different dimensions for fitting over larger size wall plates. FIG. 5 illustrates the device 10 or 15 in use to cover an exemplary wall plate 26 or 31 while a surrounding wall surface 28 is treated by painting, plastering, applying texture, or the like.

The device 10 basically comprises a hollow housing or cover shell which has a peripheral rim 20 for fitting closely over the periphery or rim 27 of a corresponding wall plate, side walls 21 extending upwardly from the rim 20, and a raised upper wall 22 for providing clearance for items projecting outwardly from a wall plate, such as switches. The upper edge of rim 20 is rounded inwardly to form a generally flat shelf or lip 23, and the side walls 21 extend upwardly from the inner edge of lip 23 to the upper wall 22, which is flat. Both the rim 20 and lip or shelf 23 fit closely over the corresponding regions of a wall plate over which the cover device is applied. The side walls 21 are tapered slightly inwardly towards the upper wall. The peripheral rim 20 is perpendicular to the flat upper wall 22 of the device.

A layer 24 of re-positionable adhesive is applied to the inner surface of the peripheral rim 20 and extends around the entire periphery of the device. The layer 24 is covered by a peel-off paper strip 25 until the device is to be used.

In the exemplary embodiment of the invention, the cover device is made of thermo-formed plastic material such as PVC of sufficient stiffness to hold its shape, but with some flexibility to provide a natural “springiness” around the rim 20 to help hold the device in position when in use. The plastic material is transparent in the exemplary embodiment but this is not essential for the purpose of the invention. The thickness of the plastic material may be of the order of 1/20 to 1/28 inch, or around 1 to 1.5 mm.

The re-positionable adhesive is a pressure sensitive liquid glue of the type used for creating a temporary bond, similar to the tacky elastic copolymer glue used on Post-It® notes. In one example of the invention, Alene's Tack-It Over & Over® glue produced by Duncan Enterprises of Fresno, Calif. was used for the adhesive layer 24.

The cover device 10 of FIGS. 1 and 3 is of predetermined rectangular shape and dimensions for fitting over wall plates of the type having two plug sockets or a single flip switch. The peripheral dimensions at the lower edge of peripheral rim 20 are slightly less than the peripheral dimensions of the wall plate it is intended to cover. In an exemplary embodiment, the device 10 has a transverse width of around 2.75 inches or 70 mm, a length of around 4.5 inches or 114 mm, and a height of around 1⅛ inches or 28.75 mm. The outer wall 22 has a transverse width of around 1.75 inches or 44.5 mm. The height of peripheral rim 20 is around ⅜ inches or 9.75 mm. The width of ledge or flat step 23 is around 0.25 inches or 6.5 mm.

FIGS. 2 and 4 illustrate an alternative cover or masking device 15 which is of larger dimensions than the device 10 and of generally square shape. This masking device is designed to fit over larger wall plates 31 of the type having two flip switches or the like. It is of similar shape to the device 10 although of larger dimensions, and like reference numerals are used for like parts of the two masking devices. The peripheral dimensions are again slightly less than those of the corresponding wall plate. In an exemplary embodiment, device 15 has a length and transverse width which are both around 4.5 inches or 114 mm. and a height identical to that of device 10. The peripheral rim 20 also has a height which is the same as that of device 10. The transverse width of the upper or outer wall 22 is around 3 inches or 76.25 mm.

The cover devices 10, 15 can be used quickly and easily when the walls of a room are to be treated in order to cover any wall plates on wall surfaces in the room and prevent any of the treatment material splashing or covering any region of the wall plate. FIG. 1 illustrates the cover device 10 positioned in alignment with a rectangular wall plate 26 prior to attachment, while FIG. 2 illustrates the larger, square cover or masking device 15 in alignment with a corresponding size wall plate 31. In order to apply the cover device 10 or 15, the peel-off paper strip 25 (see FIGS. 3 and 4) covering the adhesive layer 24 is first peeled off and discarded. The device is then pushed down over the wall plate with the peripheral rim 20 engaging closely over the matching peripheral rim 27 of the wall plate, as indicated in FIG. 5.

Since the dimensions of rim 20 are slightly less than those of rim 27, the rim 20 will be spread slightly outwardly as the device is pressed down over rim 27, ensuring a close engagement with the adhesive layer 24 and enhancing the grip of rim 20 over rim 27. When the cover device 10 is pushed completely down over the wall plate 26, the lower edge 30 of the rim 20 will contact the wall at the junction between the wall and wall plate (see FIG. 5), thus providing a barrier preventing paint from flowing under the rim into contact with the rim of the wall plate. At the same time, the adhesive layer 24 will adhere to the rim of the wall plate around the entire periphery of the device, temporarily holding it in place so that it will not accidentally be displaced while the surrounding wall is being treated. The raised upper wall 22 defines a chamber or space 32 within the device providing clearance for items projecting from a wall plate, such as a switch 34 or the like.

Once the painting or other treatment is complete, and the paint, plaster, or the like is dry, all the masking or cover devices 10, 15 can simply be pulled off the wall plates, leaving no glue residue on the plates. The used cover devices are then simply discarded.

Although the masking devices 10, 15 in the illustrated embodiments are of rectangular shape and specific size to cover two different standard size wall plates, it will be understood that such devices may be made in different shapes and sizes for covering other standard fixtures in walls and ceilings. For example, circular cover devices may be provided for adhering over fire sprinkler outlets in ceilings or circular wall light fixtures. In each case, the device will have a downturned peripheral rim for fitting closely over the peripheral rim of the device, fixture, or wall plate to be covered, with the inner surface of the rim coated with a layer of re-positionable adhesive. This provides an instant, push-down application over a fixture to be protected.

The masking method using the cover devices of this invention is much faster, more convenient, and less messy than the prior masking method of removing wall plates and covering the resulting opening with masking tape or the like. The devices 10, 15 are simple and inexpensive to make, and can be supplied in quantity at a relatively low price to painters and decorators, as well as to home owners doing their own decorating. Once decorating is complete, the devices can be easily removed simply by pulling them up off the wall plate or the like.

Although some exemplary embodiments of the invention have been described above by way of example only, it will be understood by those skilled in the field that modifications may be made to the disclosed embodiments without departing from the scope of the invention, which is defined by the appended claims

What is claimed is:

1. A masking device for covering a switch or electrical outlet covering wall plate during treatment of a surrounding wall surface, the device comprising:
a housing having an open face, an outer wall spaced from said open face, and peripheral side walls extending from the periphery of the outer wall to the open face;
the peripheral side walls forming a peripheral rim around said open face of predetermined shape and dimensions for closely fitting over the peripheral rim of a selected wall plate, the peripheral rim having an inner face; and
a layer of re-positionable adhesive applied over the inner face of said peripheral rim for temporarily adhering said rim to the peripheral rim of a wall plate;
whereby the adhesive layer temporarily secures the device to the rim of the wall plate after application of the cover device over the wall plate.

2. The device as claimed in claim 1, further comprising a peel-off cover layer covering said adhesive strip.

3. The device as claimed in claim 1, wherein the re-positionable adhesive is a pressure sensitive liquid glue for forming a temporary bond.

4. The device as claimed in claim 1, wherein the housing is of generally rectangular shape.

5. The device as claimed in claim 1, wherein the outer wall is flat and the peripheral rim is substantially perpendicular to the outer wall.

6. The device as claimed in claim 1, wherein the outer wall is of smaller dimensions than the open face, and the side walls are tapered inwardly from the peripheral rim up to the outer wall.

7. The device as claimed in claim 1, wherein the peripheral rim has a lower edge for contacting a wall at the junction between the rim of a wall plate and the wall when the device is applied over the wall plate.

8. The device as claimed in claim 1, wherein the peripheral rim has an inwardly rounded upper corner and a generally flat ledge extends inwardly from the upper corner up to the remainder of the side wall.

9. The device as claimed in claim 1, wherein the peripheral rim has dimensions slightly less than the dimensions of the peripheral rim of a wall plate over which it is to be fitted, and the device is formed of a material having some resilience to allow the peripheral rim to spread over the rim of the wall plate when the device is fitted over a wall plate.

10. The device as claimed in claim 9, wherein the device is of generally square shape having a length and width which are approximately equal and are each around 4.5 inches.

11. The device as claimed in claim 9, wherein the device is rectangular and has a length of about 4.5 inches and a transverse width of about 2.75 inches.

12. The device as claimed in claim 9, wherein the peripheral rim has a height of around ⅜ inch.

13. A method of covering a wall plate during treatment of a surrounding wall surface, comprising the steps of:
providing a protective cover device for fitting closely over the wall plate, the cover device having a peripheral rim for fitting closely over the peripheral rim of the wall plate,
the peripheral rim having an inner face covered by a layer of re-positionable adhesive;
placing the protective cover device over the wall plate such that the peripheral rim of the device engages over the peripheral rim of the wall plate up to the junction between the wall plate and surrounding wall surface;
temporarily adhering the peripheral rim of the cover device to the peripheral rim of the wall plate with the layer of re-positionable adhesive;
treating the wall surface surrounding the wall plate; and
on completion of the wall treatment, removing the protective cover from the wall plate and discarding it.
